(19) United States
(12) Patent Application Publication
(10) Pub. No.: US 2014/0267593 A1
(43) Pub. Date: Sep. 18, 2014

(54) METHOD FOR PROCESSING IMAGE AND ELECTRONIC DEVICE THEREOF

(71) Applicants: SNU R&DB FOUNDATION, Seoul (KR); Samsung Electronics Co., Ltd., Suwon-si (KR)

(72) Inventors: Byeong-Jae KIM, Dongducheon-si (KR); Sang Hwa LEE, Seoul (KR)

(73) Assignees: SNU R&DB FOUNDATION, Seoul (KR); Samsung Electronics Co., Ltd., Suwon-si (KR)

(21) Appl. No.: 14/212,098

(22) Filed: Mar. 14, 2014

(30) Foreign Application Priority Data
Mar. 14, 2013 (KR) 10-2013-0027582

(51) Int. Cl. H04N 5/232

(52) U.S. Cl. CPC H04N 5/23238
USPC 348/36

(57) ABSTRACT

A method for generating a panoramic image and an electronic device thereof are provided. The method includes displaying guide information for guiding a movement of the electronic device on a display of the electronic device in order to obtain images forming at least a portion of a panoramic image, obtaining at least one image based on the guide information and orientation information of the electronic device, correcting a color of images based on at least a portion of the obtained images in order to form at least the portion of the panoramic image, aligning the images based on at least a portion where the obtained images have overlapped, and generating the panoramic image by projecting the aligned images onto a three-Dimensional (3-D) sphere.

### CROSS-REFERENCE TO RELATED APPLICATION(S)

This application claims the benefit under 35 U.S.C. §119(a) of a Korean patent application filed on Mar. 14, 2013 in the Korean Intellectual Property Office and assigned Serial number 10-2013-0027582, the entire disclosure of which is hereby incorporated by reference.

### TECHNICAL FIELD

The present disclosure relates to a method for processing an image and an electronic device thereof. More particularly, the present disclosure relates to a method for generating a panoramic image by projecting images obtained via a camera onto a sphere in an electronic device.

### BACKGROUND

With an information communication technology and a semiconductor technology, an electronic device evolves to a multimedia apparatus for providing various multimedia services. For example, a portable electronic device may provide various multimedia services, such as a broadcasting service, a wireless Internet service, a camera service, a music reproduction service, and the like.

Recently, an electronic device may provide a function for obtaining various images using an image sensor, and processing the obtained image in various ways. For example, the electronic device may provide a panoramic image generation technology of connecting a plurality of images obtained while changing an image capturing angle to reconstruct one image.

A need exists for an apparatus and a method for generating a panoramic image by projecting images obtained via a camera onto a sphere in an electronic device.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an apparatus and a method for generating a panoramic image by projecting images obtained via a camera onto a sphere in an electronic device.

According to embodiments of the present disclosure, an electronic device may generate a panoramic image in various ways. For example, an electronic device may obtain images of various points successively in a vertical direction or a horizontal direction. Thereafter, the electronic device may reconstruct images of a wide region as one image by connecting images of various points using characteristic points of respective images and projecting the same on a cylinder or a sphere.

Another aspect of the present disclosure is to provide an apparatus and a method for generating a panoramic image in an electronic device.

Still another aspect of the present disclosure is to provide an apparatus and a method for generating a panoramic image by projecting two-Dimensional (2-D) images obtained via a camera onto a three-Dimensional (3-D) sphere in an electronic device.

Yet another aspect of the present disclosure is to provide an apparatus and a method for obtaining images in the front direction via a camera in order to generate a panoramic image by projecting images onto a sphere in an electronic device.

Further another aspect of the present disclosure is to provide an apparatus and a method for obtaining a plurality of images to project onto a sphere based on orientation (e.g., a movement, a position, a direction, and the like) information of an electronic device in the electronic device.

Still further another aspect of the present disclosure is to provide an apparatus and a method for displaying reference frame information for obtaining a plurality of images to project onto a sphere depending on movement information of an electronic device in the electronic device.

In accordance with an aspect of the present disclosure, a method for operating an electronic device is provided. The method includes displaying guide information for guiding a movement of the electronic device on a display of the electronic device in order to obtain images forming at least a portion of a panoramic image, obtaining at least one image based on the guide information and orientation information of the electronic device, correcting a color of images based on at least a portion of the obtained images in order to form at least the portion of the panoramic image, aligning the images based on at least a portion where the obtained images have overlapped, and generating the panoramic image by projecting the aligned images onto a three-dimensional sphere.

In accordance with an aspect of the present disclosure, the guide information includes at least one image capturing region for obtaining regions forming at least the portion of the panoramic image in a form of a sphere.

In accordance with another aspect of the present disclosure, an electronic device is provided. The electronic device includes a camera, a detecting unit for detecting a movement of the electronic device, a display unit, one or more processors, a memory, and a program stored in the memory and driven by the one or more processors, wherein the program displays guide information for guiding a movement of the electronic device on the display unit of the electronic device in order to obtain images forming at least a portion of a panoramic image, obtains at least one image based on the guide information and orientation information of the electronic device, corrects a color of images based on at least a portion of the obtained images in order to form at least the portion of the panoramic image, aligns the images based on at least a portion where the obtained images have overlapped, and generates the panoramic image by projecting the aligned images onto a 3-D sphere.

In accordance with another aspect of the present disclosure, the guide information includes at least one image capturing region for obtaining regions forming at least the portion of the panoramic image in a form of a sphere.

In accordance with still another aspect of the present disclosure, a method for generating an image in an electronic device is provided. The method includes displaying guide information for guiding a movement of the electronic device on a display of the electronic device in order to obtain an image forming at least a portion of a panoramic image, obtaining at least one image based on orientation information of the electronic device and the guide information, transforming a 2-D coordinate value of the at least one image into a 3-D coordinate value, and projecting the at least one image onto a 3-D sphere using a 3-D coordinate value of the image.

In accordance with yet another aspect of the present disclosure, a method for operating an electronic device is provided. The method includes displaying at least a portion of a plurality of guides generated based on at least a portion of a camera's angle of the electronic device on a display of the electronic device in order to obtain images forming at least a portion of a 3-D projected panoramic image, each of the plurality of guides corresponding to one of a plurality of coordinate values, determining a value representing a movement direction of the electronic device using a sensor of the electronic device, comparing the determined value with at least one of the coordinate values, obtaining an image using the camera based on at least a portion of the comparison result in the comparison operation, and generating a panoramic image on the display by projecting an image stored in advance in the electronic device and the obtained image onto a 3-D sphere.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating an electronic device according to an embodiment of the present disclosure;

FIG. 2 is a block diagram illustrating a processor according to an embodiment of the present disclosure;

FIG. 3 is a block diagram illustrating a panoramic image generator according to an embodiment of the present disclosure;

FIG. 4 is a flowchart illustrating a procedure for generating a panoramic image in an electronic device according to an embodiment of the present disclosure;

FIG. 5 is a flowchart illustrating a procedure for obtaining an image for generating a panoramic image in an electronic device according to an embodiment of the present disclosure;

FIG. 6 is a flowchart illustrating a procedure for obtaining an image for generating a panoramic image in an electronic device according to an embodiment of the present disclosure;

FIGS. 7A, 7B, and 7C illustrate a screen configuration of a reference frame according to an embodiment of the present disclosure;

FIG. 8 illustrates a tile construction of a reference frame according to an embodiment of the present disclosure;

FIG. 9 illustrates a band construction of a sphere according to an embodiment of the present disclosure;

FIGS. 10A, 10B, and 10C illustrate a screen configuration for correcting exposure of images in an electronic device according to an embodiment of the present disclosure;

FIG. 11 illustrates a procedure for aligning images in an electronic device according to an embodiment of the present disclosure;

FIG. 12 illustrates a screen construction for obtaining a vertex of an image in an electronic device according to an embodiment of the present disclosure;

FIGS. 13A, 13B, and 13C illustrate a screen configuration for extracting an overlap region in an electronic device according to an embodiment of the present disclosure;

FIG. 14 illustrates a construction for projecting a two-Dimensional (2-D) image to a three-Dimensional (3-D) sphere according to an embodiment of the present disclosure;

FIGS. 15A, 15B, 15C, and 15D illustrate a screen configuration for enlarging/reducing an image projected onto a (3D) sphere according to an embodiment of the present disclosure;

FIG. 16 illustrates contents of a file stored in an electronic device according to an embodiment of the present disclosure;

FIG. 17 illustrates a software configuration of an electronic device according to an embodiment of the present disclosure; and

FIG. 18 is a block diagram of an electronic device according to an embodiment of the present disclosure.

Throughout the drawings, like reference numerals will be understood to refer to like parts, components and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

Hereinafter, an embodiment of the present disclosure describes a method for generating a panoramic image in an electronic device.

In the following description, an electronic device includes a mobile communication terminal having a camera and a movement sensor, a Personal Digital Assistant (PDA), a Personal Computer (PC), a laptop computer, a smartphone, a netbook computer, a television, a Mobile Internet Device (MID), an Ultra Mobile Personal Computer (UMPC), a tablet PC, a navigation, a smart TV, a wrist watch, a digital camera, a Motion Pictures Expert Group (MPEG-1 or MPEG-2) Audio Layer 3 (MP3) player, and the like.

FIG. 1 is a block diagram illustrating an electronic device according to an embodiment of the present disclosure. FIGS. 7A, 7B, and 7C illustrate a screen configuration of a reference frame according to an embodiment of the present disclosure.

Referring to FIG. 1, an electronic device 100 may include a memory 110, a processor unit 120, an audio processor 130, a camera unit 140, a detecting unit 150, an Input/Output (I/O) controller 160, a display unit 170, and an input unit 180. Here, a plurality of memories 110 may exist.

The memory 110 may include a program storage 111 for storing a program for controlling an operation of the electronic device 100, and a data storage 112 for storing data occurring during execution of a program. The memory 110 may be a volatile memory (for example, a Random Access Memory (RAM), and the like) or a non-volatile memory (for example, a flash memory, and the like), or a combination thereof.

The data storage 112 stores reference frame information and panoramic image information. For example, the data storage 112 may transform a three-Dimensional (3-D) coordinate value projected onto a 3-D sphere by a panoramic image generation program 114 to a mesh data form, and store the same. For another example, the data storage 112 may transform a 3-D coordinate value projected onto a 3-D sphere by the panoramic image generation program 114 to a two-Dimensional (2-D) plane coordinate, and store the same.

FIG. 16 illustrates contents of a file stored in an electronic device according to an embodiment of the present disclosure.

Referring to FIG. 16, at this point, the data storage 112 may store at least one 2-D image obtained via the panoramic image generation program 114 in order to project the same onto the sphere. Here, the reference frame information may include guide information provided to a user for obtaining images used for generating a panoramic image by the panoramic image generation program 114.

The program storage 111 may include a Graphical User Interface (GUI) program 113, the panoramic image generation program 114, and at least one application 115. Here, a program included in the program storage 111 is a set of instructions and may be expressed as an instruction set.

The GUI program 113 includes at least one software element for providing a user interface using graphics on the display unit 170. The GUI program 113 may control to display information of an application driven by the processor 122 on the display unit 170. For example, in a case where the panoramic image generation program 114 is executed by the processor 122, the GUI program 113 may control to display a portion of a reference frame representing a relative position of at least one image that should be obtained for generating a panoramic image using an image 701 obtained via the camera unit 140 as a reference on the display unit 170 as illustrated in FIG. 7A. For another example, in the case where the panoramic image generation program 114 is executed by the processor 122, the GUI program 113 may control to display an entire construction of a reference frame representing a relative position of at least one image that should be obtained for generating a spherical panoramic image on the display unit 170 as illustrated in FIG. 7B. In addition, for another example, in the case where the panoramic image generation program 114 is executed by the processor 122, the GUI program 113 may control to display central points 715 and 717 of at least one image that should be obtained for generating a spherical panoramic image using an image 711 obtained via the camera unit 140 as a reference on the display unit 170 as illustrated in FIG. 7C.

The panoramic image generation program 114 includes at least one software element for generating a panoramic image using images obtained via the camera unit 140. For example, the panoramic image generation program 114 obtains a plurality of images for generating a panoramic image based on orientation information of the electronic device 100 provided from the detecting unit 150. More specifically, in a case of displaying a reference frame on the display unit 170 as illustrated in FIG. 7A or 7B, the panoramic image generation program 114 may determine an image capturing point based on absolute or relative position information of a tile of the reference frame illustrated in FIG. 7A or 7B and orientation information of the electronic device 100 provided from the detecting unit 150, and obtain an image via the camera unit 140. At this point, the tile may include fixed position information or include relative position information depending on position information of a reference image. Meanwhile, in a case of displaying the central points 715 and 717 of a region for obtaining an image on the display unit 170 as illustrated in FIG. 7C, the panoramic image generation program 114 may determine an image capturing point based on orientation information of the electronic device 100 provided from the detecting unit 150 and absolute and relative position information of a region for obtaining an image to obtain an image via the camera unit 140. For example, the panoramic image generation program 114 may obtain an image of a point at which the central points 715 and 717 enter the inside of a circle 713 representing the direction of the camera unit 140 via the camera unit 140.

Thereafter, the panoramic image generation program 114 may correct a color of images obtained from different directions. For example, the panoramic image generation program 114 may correct a brightness value and/or a color value generated by an exposure difference of images obtained from different directions. For example, the panoramic image generation program 114 may correct brightness values of images such that the brightness values of the images are the same or have a difference of an error range based on at least one of an average brightness value and a standard deviation of brightness values of a region where images overlap. For another example, the panoramic image generation program 114 may change or correct color values of images such that the color values are the same or have a difference of an error range based on a difference of a color value of a region where images overlap. For still another example, the panoramic image generation program 114 may change or correct a brightness value and a color value of images such that they are the same or have a difference of an error range based on a difference in a brightness value and a color value where images overlap. Here, the brightness value of images may include a brightness component (Y component) among YUV components, and the color value may include a UV component. In addition, the region where images overlap may represent a region where the images overlap when the images are projected onto a sphere.

The panoramic image generation program 114 aligns images in order to match an overlapping region of images whose exposure difference has been corrected. For example, in the case where the panoramic image generation program 114 obtains an image, each image may include a movement detect error of the detecting unit 150 and an error generated when an image is obtained. Accordingly, the panoramic image generation program 114 may correct a matching error for an overlapping region of a first image and a second image by rotating an angle of the second image that overlaps the first image when projecting the images onto a sphere. For example, the panoramic image generation program 114 may correct a matching error such that overlapping regions of the first image and the second image are connected naturally by rotating an angle of the second image with respect to the first image. For another example, the panoramic image generation program 114 may change a position, a size, and rotation of overlapping images depending on input information provided from the input unit 180 to align images. For example, the panoramic image generation program 114 may change a position, a size, and rotation of the second image with respect to the first image depending on input information provided from the input unit 180 to correct a matching error such that the overlapping regions of the first image and the second image are connected naturally.

The panoramic image generation program 114 may generate a panoramic image by projecting 2-D images whose exposure differences and error in movement information have been corrected onto a 3-D sphere. At this point, the electronic device may generate a panoramic image using a radius of a sphere for generating a panoramic image and a focal length of the camera unit 140 for obtaining an image.

Additionally, the panoramic image generation program 114 may mix or blur portions where images overlap in order to allow images projected onto the sphere to be connected naturally.

The application 115 includes a software element for at least one application installed to the electronic device 100.

The processor unit 120 includes a memory interface 121, at least one processor 122, and a peripheral interface 123. Here, the memory interface 121, the at least one processor 122, and the peripheral interface 123 included in the processor unit 120 may be integrated in at least one integrated circuit or implemented as separate elements.

The memory interface 121 controls an access of an element, such as the processor 122 or the peripheral interface 123, to the memory 110.

The peripheral interface 123 controls connection between I/O peripherals of the electronic device 100, and the processor 122 and the memory interface 121.

The processor 122 controls the electronic device 100 to provide various multimedia services using at least one software program. At this point, the processor 122 executes at least one program stored in the memory 110 to provide a service corresponding to a relevant program.

The audio processor 130 provides an audio interface between a user and the electronic device 100 via a speaker 131 and a microphone 132.

The camera unit 140 provides a collected image, obtained via image capturing, to the processor unit 120. More specifically, the camera unit 140 may include a camera sensor for converting an optical signal to an electric signal, an image processor for converting an analog image signal to a digital image signal, and a signal processor for processing an image to display an image signal output from the image processor on the display unit 170. Here, the camera unit 140 may include at least one camera unit provided by the electronic device 100.

The detecting unit 150 detects a movement of the electronic device 100. For example, the detecting unit 150 includes an acceleration sensor, a gravity sensor, a gyro compass, a digital compass, a horizontal sensor, or a geomagnetic sensor, and the like, to detect the direction of the electronic device 100. Here, the movement of the electronic device 100 may represent orientation information of the electronic device 100.

The I/O controller 160 provides an interface between an I/O unit, such as the display unit 170 and the input unit 180, and the peripheral interface 123.

The display unit 170 displays a character input by a user, a moving picture, or a still picture, and the like. The display unit 170 may display information of an application driven by the processor 122. For example, in the case where the panoramic image generation program 114 is executed by the processor 122, the display unit 170 may display at least one tile adjacent to the position of a preview image 701 obtained by the camera unit 140 as illustrated in FIG. 7A. At this point, in the case where the position of the preview image obtained by the camera unit 140 changes depending on the direction of the electronic device 100, the display unit 170 may change the number of displayed tiles and the position of the displayed tiles depending on the position change of the preview image. For another example, in the case where the panoramic image generation program 114 is executed by the processor 122, the display unit 170 may display an entire construction of a reference frame for obtaining an image to project onto a sphere as illustrated in FIG. 7B. For still another example, in the case where the panoramic image generation program 114 is executed by the processor 122, the display unit 170 may display the central points 715 and 717 of a position information region for obtaining an image to project onto a sphere using a point 711 at which an image is obtained via the camera unit 140 as a reference as illustrated in FIG. 7C. At this point, the display unit 170 may represent distance information up to the point 711 at which an image is obtained by controlling at least one of color, illuminance, and transparency of the central points 715 and 717 for obtaining an image. In addition, the display unit 170 may display the direction of position information adjacent to a circle 713 representing the direction of the camera unit 140. For another example, in the case where the panoramic image generation program 114 aligns an image depending on input information provided from the input unit 180, the display unit 170 may display selection information on an image selected by the input information.

The input unit 180 provides input data generated by a user's selection to the processor unit 120 via the I/O controller 160. At this point, the input unit 180 may include a keypad including at least one hardware button and a touch pad for detecting touch information, and the like. For example, the input unit 180 provides touch information detected via the touch pad to the processor 122 via the I/O controller 160.

Additionally, the electronic device 100 may include a communication system for performing a communication function for voice communication and data communication. At this point, the communication system may be divided into a plurality of communication sub modules supporting different communication networks. For example, though not limited thereto, the communication network includes a Global System for Mobile communications (GSM) network, an Enhanced Data rates for GSM Evolution (EDGE) network, a Code Division Multiple Access (CDMA) network, a Wideband-CDMA (W-CDMA) network, a Long Term Evolution (LTE) network, an Orthogonal Frequency Division Multiple Access (OFDMA) network, a wireless Local Area Network (LAN), a Bluetooth network, NFC, and the like.

FIG. 2 is a block diagram illustrating a processor according to an embodiment of the present disclosure. FIG. 3 is a block diagram illustrating a panoramic image generator according to an embodiment of the present disclosure.

Referring to FIG. 2, the processor 122 may include an application driver 200, a panoramic image generator 210, and a display controller 220. In an embodiment of FIG. 2, elements of the processor 122 are formed as separate modules. In another embodiment of the present disclosure, the elements may be included as software elements inside one module.

The application driver 200 executes at least one application 115 stored in the program storage 111 to provide a service corresponding to a relevant program. At this point, the application driver 200 may drive a panoramic image generator 210 depending on a service characteristic.

The panoramic image generator 210 may execute the panoramic image generation program 114 stored in the program storage 111 to generate a panoramic image projected onto a sphere.

Referring to FIG. 3, for example, the panoramic image generator 210 may include an image obtaining unit 300, an exposure corrector 310, an image aligner 320, and a spherical projector 330.

The image obtaining unit 300 obtains a plurality of images for generating a panoramic image based on orientation information of the electronic device 100 provided from the detecting unit 150. For example, in the case where a reference frame including at least one tile is displayed as illustrated in FIGS. 7A or 7B, the image obtaining unit 300 may determine an image capturing point via the camera unit 140 based on the orientation information of the electronic device 100 provided from the detecting unit 150 and absolute or relative position information of a tile included in the reference frame. At this point, the tile may include fixed position information or include relative position information depending on position information of a reference image. For another example, in the case where the central points 715 and 717 of a region for obtaining an image are displayed on the display unit 170 as illustrated in FIG. 7C, the image obtaining unit 300 may determine an image capturing point based on the orientation information of the electronic device 100 provided from the detecting unit 150 and absolute or relative position information for obtaining an image, and obtain an image via the camera unit 140. For example, the image obtaining unit 300 may obtain an image of a point at which the central points 715 and 717 enter the inside of the circle 713 representing the direction of the camera unit 140 via the camera unit 140.

When the image obtaining unit 300 obtains an image, the exposure corrector 310 may correct a color of images obtained from different directions. For example, the exposure corrector 310 may correct a change in a brightness value and/or a color value generated by an exposure difference of images obtained from different directions. At this point, the exposure corrector 310 may correct a brightness value of images based on at least one of an average and a standard deviation of brightness values for an overlapping region when images are projected onto a sphere.

FIGS. 10A, 10B, and 10C illustrate a screen configuration for correcting exposure of images in an electronic device according to an embodiment of the present disclosure.

Referring to FIGS. 10A, 10B, and 10C, for example, in a case of synthesizing a first image illustrated in FIG. 10A and a second image illustrated in FIG. 10B obtained via the image obtaining unit 300 without exposure correction, a problem that the brightness and the color of the synthesized image are not constant due to an exposure difference of the first image and the second image as illustrated in FIG. 10C may occur. Accordingly, the exposure corrector 310 may correct brightness values of images such that the brightness values are the same or have a difference of an error range based on at least one of an average brightness value and a standard deviation of brightness values of a region where images obtained from the image obtaining unit 300 overlap. The exposure corrector 310 may change or correct color values of images such that the color values are the same or have a difference of an error range based on a color value of a region where images overlap. In addition, the exposure corrector 310 may change or correct brightness values and color values of images such that they are the same or have a difference of an error range based on a difference in a brightness value and a color value of a region where images overlap. Here, a brightness value of images may include a brightness component (Y component) among YUV components, and a color value may include a UV component.

More specifically, for example, the exposure corrector 310 may correct brightness of overlapping images based on a difference in an average brightness value of images as in Equation (1). Here, it is assumed that the exposure corrector 310 corrects an exposure difference of the second image illustrated in FIG. 10B using the first image illustrated in FIG. 10A as a reference.

I_{meansub}(x,y)=I_{Cur}(x,y)+(M_{ref}−M_{Cur}) Equation (1)

In Equation (1), I_{meansub}(x,y) is a corrected brightness value of a coordinate (x, y), I_{Cur}(x,y) is a brightness value of a coordinate (x,y) included in the second image, M_{ref} is an average of a brightness value of a region overlapping the second image in the first image, and M_{Cur} is an average of a brightness value of a region overlapping the first image in the second image.

For example, the exposure corrector 310 may correct an exposure difference between the first image and the second image based on a difference in an average brightness value of an overlapping region of the first image and the second image.

In addition, the exposure corrector 310 may correct brightness of overlapping images based on a standard deviation of a brightness value for images as illustrated in FIG. 2. Here, it is assumed that the exposure corrector 310 corrects an exposure difference of the second image illustrated in FIG. 10B using the first image illustrated in FIG. 10A as a reference.

$${I}_{Devratio} ( x , y ) = {M}_{Cur} ( x , y ) + ( {I}_{Cur} ( x , y ) - {M}_{Cur} ) \times \frac{{σ}_{cur}}{{σ}_{ref}} \qquad Equation ( 2 )$$

In Equation (2), I_{Devratio}(x,y) is a corrected brightness value of a coordinate (x, y), I_{Cur}(x,y) is a brightness value of a coordinate (x, y) included in the second image, M_{Cur} is an average of a brightness value of a region overlapping the first image in the second image, σ_{Cur} is a standard deviation of a brightness value of a region overlapping the first image in the second image, and σ_{ref} is a standard deviation of a brightness value of a region overlapping the second image in the first image.

For example, the exposure corrector 310 may correct an exposure difference between the first image and the second image based on a ratio of a standard deviation to a brightness value of an overlapping region of the first image and the second image.

In addition, the exposure corrector 310 may correct brightness of overlapping images based on a difference in an average brightness value of images as in Equation (3). Here, it is assumed that the exposure corrector 310 corrects an exposure difference of the second image illustrated in FIG. 10B using the first image illustrated in FIG. 10A as a reference.

$${I}_{meanratio} ( x , y ) = {I}_{Cur} ( x , y ) \times \frac{{M}_{Cur}}{{M}_{ref}} \qquad Equation ( 3 )$$

In Equation (3), Iₘₑₐₙᵣₐₜᵢₒ(x,y) is a corrected brightness value of a coordinate (x, y), I_{cur}(x,y) is a brightness value of a coordinate (x, y) included in the second image, M_{ref} is an average of a brightness value of a region overlapping the second image in the first image, and M_{Cur} is an average of brightness values of a region overlapping the first image in the second image.

For example, the exposure corrector 310 may correct an exposure difference between the first image and the second image based on a ratio of an average brightness value of an overlapping region to the first image and the second image.

The image aligner 320 may correct a movement detect error of the detecting unit 150 and an error generated when an image is obtained via template matching with respect to images whose exposure difference has been corrected. For example, the image aligner 320 may match an overlapping region of images when projecting the images onto a sphere via template matching. For example, the image aligner 320 obtains coordinates via which vertexes of respective images whose exposure differences have been corrected by the exposure corrector 310 are projected onto a sphere. Thereafter, the image aligner 320 extracts an overlapping region when images are projected onto a sphere with vertexes of respective images used as a reference, and calculates a correlation for the overlapping regions. For example, the image aligner 320 calculates a similarity between two images in the overlapping region. At this point, the image aligner 320 may determine correlation between images for the overlapping region using at least one of an SSD method, an SAD method, and a normal correlation coefficient method. Thereafter, the image aligner 320 may correct a matching error for the overlapping region by changing a rotation angle of an overlapping image using one image as a reference in order to obtain an effect of moving on a sphere.

For another example, the image aligner 320 may also align images by changing the position, size and rotation of overlapping images depending on input information provided from the input unit 180.

The spherical projector 330 may generate a panoramic image by projecting 2-D images matched by the image aligner 320 onto a 3-D sphere.

FIG. 14 illustrates a construction for projecting a 2-D image to a 3-D sphere according to an embodiment of the present disclosure.

Referring to FIG. 14, for example, in a case of projecting a 2-D image 1400 illustrated in FIG. 14 onto a 3-D sphere 1410, the spherical projector 330 transforms a coordinate (x, y) of a 2-D image to a 3-D spacial coordinate (x, y, f) because a coordinate of a 2-D image does not one-to-one correspond to a coordinate of a 3-D sphere. At this point, the spherical projector 330 may transform a coordinate (x, y) of a 2-D image to a 3-D spacial coordinate (x, y, f) by setting a distance of a 2-D image with respect to a center point of the sphere to a focal length f. Thereafter, the spherical projector 330 may project an image having a 3-D spacial coordinate onto an image using Equation (4) below.

$$\begin{matrix}( u , v , w ) = \frac{r}{\sqrt{{x}^{2} + {y}^{2} + {f}^{2}}} ( x , y , f ) \\ = ( r cos θ cos φ , r cos θsinφ , r sin φ )\end{matrix} \qquad Equation ( 4 )$$

In Equation (4), (u, v, w) is a coordinate obtained by projecting a spacial coordinate of a 2-D image onto a 3-D sphere, (x, y, f) is a spacial coordinate of a 2-D image, r is a radius of a sphere for projecting an image, θ and φ are angles of an image coordinate in a 3-D space by a spherical coordinate system.

For another example, the spherical projector 330 may project a 3-D spacial coordinate (x′, y′, z′) generated using a 3-D transform matrix as in Equation (5) onto a sphere as in Equation (6). At this point, the spherical projector 330 may generate a 3-D rotation transform matrix using a rotation angle detected by the detecting unit 150 when an image is obtained.

$$[ \begin{matrix}{x}^{′} \\ {y}^{′} \\ {z}^{′}\end{matrix} ] = R [ \begin{matrix}x \\ y \\ z\end{matrix} ] \qquad Equation ( 5 )$$

In Equation (5), (x′, y′, z′) is a 3-D spacial coordinate generated with reference to one of directions, (x,y,f) is a spacial coordinate of a 2-D image, and R is a 3-D rotation transform matrix.

The spherical projector 330 transforms a spacial coordinate of a 2-D image using a 3-D rotation transform matrix according to Equation (5) to obtain a 3-D spacial coordinate. For example, the spherical projector 330 may generate a 3-D coordinate of an image based on a spacial direction in which a camera has obtained an image.

$$( u , v , w ) = \frac{r}{\sqrt{{x}^{′2} + {y}^{′2} + {z}^{′2}}} ( {x}^{′} , {y}^{′} , {z}^{′} ) \qquad Equation ( 6 )$$

In Equation (6), (u, v, w) is a coordinate obtained by projecting a spacial coordinate of a 2-D image onto a 3-D sphere, (x′, y′, z′) is a 3-D spacial coordinate generated with reference to one of directions, and r is a radius of a sphere for projecting an image.

FIGS. 15A, 15B, 15C, and 15D illustrate a screen configuration for enlarging/reducing an image projected onto a (3D) sphere according to an embodiment of the present disclosure.

Referring to FIGS. 15A, 15B, 15C, and 15D, the spherical projector 330 may project a 2-D image onto a 3-D sphere using a radius of the sphere and a focal length of the camera unit 140 for obtaining an image as in Equation (4) or (6). At this point, the electronic device may enlarge/reduce an original image of FIG. 15A by controlling the radius of the sphere and the focal length when projecting the image onto the sphere as illustrated in FIGS. 15B, 15C, and 15D. More specifically, in a case of projecting an image of 256×256 pixel illustrated in FIG. 15A onto a sphere depending on the radius of a 100-pixel sphere and a 200-pixel focal length, the electronic device may obtain an image projected onto the sphere as illustrated in FIG. 15B. In addition, in a case of projecting an image of 256×256 pixel illustrated in FIG. 15A onto a sphere depending on the radius of a 350-pixel sphere and a 500-pixel focal length, the electronic device may obtain an image projected onto the sphere as illustrated in FIG. 15C. In addition, in a case of projecting the image of 256×256 pixel illustrated in FIG. 15A onto a sphere depending on the radius of a 500-pixel sphere and a 700-pixel focal length, the electronic device may obtain an image projected onto the sphere as illustrated in FIG. 15D.

Additionally, the panoramic image generator 210 may further include an image synthesizer 340. At this point, the image synthesizer 340 may remove a boundary of an overlapping region of images projected onto a sphere by the spherical projector 330 by blurring or mixing the boundary of the overlapping images. In addition, the panoramic image generator 210 may perform stitching for images projected onto a sphere.

The display controller 220 may control to display a user interface on the display unit 170 using graphics by executing the GUI program 113 stored in the program storage 111. The display controller 220 controls to display information of an application driven by the application driver 200 on the display unit 170. For example, in the case where the panoramic image generator 210 is driven, the display controller 220 may control to display at least one tile adjacent to the position of the preview image 701 obtained by the camera unit 140 as illustrated in FIG. 7A. At this point, in the case where the position of a preview image obtained by the camera unit 140 changes depending on orientation information of the electronic device 100, the display controller 220 may change the number of tiles and the position of the tiles displayed on the display unit 170 depending on the position change of the preview image. For another example, in the case where the panoramic image generator 210 is driven, the display controller 220 may control to display an entire construction of a reference frame for obtaining an image to project onto a sphere on the display unit 170 as illustrated in FIG. 7B. For still another example, in the case where the panoramic image generator 210 is driven, the display controller 220 may control to display the central points 715 and 717 of a region for obtaining an image to project onto a sphere using the point 711 at which an image is obtained via the camera unit 140 as a reference on the display unit 170 as illustrated in FIG. 7C.

In the above various embodiments of the present disclosure, the electronic device 100 may generate a panoramic image projected onto a sphere using the processor 122 including the panoramic image generator 210.

In another embodiment of the present disclosure, the electronic device 100 may include a separate control module for generating a panoramic image projected onto a sphere.

As described above, the electronic device provides a reference frame in order to obtain images used for generating a panoramic image. For example, the reference frame is user guide information for obtaining an image to project onto a sphere as illustrated in FIG. 7B, and may include a plurality of tiles including position information for obtaining each region.

In the case where the electronic device 100 generates a panoramic image using a sphere, the electronic device may configure a reference frame using a square-shaped tile in order to normalize a rotation angle of each image in a vertical direction and a horizontal direction. For example, the electronic device 100 may configure a reference frame using a square-shaped tile in order to prevent a rotation angle of images and a magnitude of an overlapping region from changing in the horizontal direction and the vertical direction since the horizontal length and the vertical length of an image are different.

FIG. 8 illustrates a tile construction of a reference frame according to an embodiment of the present disclosure.

Referring to FIG. 8, for example, the electronic device 100 may determine the magnitude of a tile. More specifically, the camera unit 140 of the electronic device 100 has a fixed Field Of View (FOV) 801 and an Angle Of View (AOV) 803. At this point, on the assumption of normalizing a focal length to 1 on a tile and calculating a Field Of View of a Camera (FOVcam) 801 on a pixel basis, the electronic device 100 may determine the focal length of the camera unit 140 and the number of tiles and a magnitude of a tile (i.e., a field of view of a tile 807 and an angle of view of a tile 805) to apply to a central band of a sphere used for generating a panoramic image using Equations (7) to (10). Here, the band represents a region of the horizontal direction where an angle of the vertical direction from the central region of the sphere is included within a range.

$$f = \frac{F O {V}_{cam}}{2 tna ( \frac{A O {V}_{cam}}{2} )} \qquad Equation ( 7 )$$

In Equation (7), f is the focal length of the camera unit 140, FOV_{cam} is a field of view of the camera unit 140, and AOV_{cam} is an angle of view of the camera unit 140.

$${TN}_{MB} = ceil ( \frac{360}{A O {V}_{cam}} ) \qquad Equation ( 8 )$$

In Equation (8), TN_{MB} is the number of tiles that can be obtained while the image obtaining unit 300 rotates in the horizontal direction in the central band of a sphere onto which an obtained image is to be projected, AOV_{cam} is an angle of view of the camera unit 140, and ceil (f(x)) is a rising operation for an f(x) operation value.

$$A O {V}_{Tile} = \frac{360}{{TN}_{MB}} \qquad Equation ( 9 )$$

In Equation (9), AOV_{Tile} is an angle of view of a tile, and TN_{MB} is the number of tiles that can be obtained while the image obtaining unit 300 rotates in the horizontal direction in the central band of a sphere onto which an obtained image is to be projected.

$$F O {V}_{Tile} = 2 f tan ( \frac{A O {V}_{Tile}}{2} ) \qquad Equation ( 10 )$$

In Equation (10), FOV_{Tile} is a field of view of a tile, AOV_{Tile} is an angle of view of a tile, and f is the focal length of the camera unit 140.

The electronic device 100 may set a tile such that a region where an angle of view of an image belonging to one tile overlaps between images occurs at a ratio for matching between tile images. Accordingly, the electronic device 100 may determine the number of tiles that can be obtained while rotating in the horizontal direction in the central band of a sphere using Equation (11).

$$C T {N}_{MB} = ceil ( T {N}_{MB} \times P ) \\ I D = \frac{360}{C T {N}_{MB}} \qquad Equation ( 11 )$$

In Equation (11), CTN_{MB} is the number of tiles to obtain while rotating in the horizontal direction in the central band of a sphere so that images overlap, TN_{MB} is the number of tiles that can be obtained while rotating in the horizontal direction in the central band of a sphere so that images do not overlap, and P is a ratio at which images overlap. Here, P may be set to a value between 1.0˜2.0. For example, in the case where P is set to 1.3, the electronic device 100 may configure a reference frame so that a tile magnitude overlaps by 30%.

At this point, the electronic device 100 may calculate an image interval (ID) by a tile of the central band using CTN_{MB} as in Equation (11).

FIG. 9 illustrates a band construction of a sphere according to an embodiment of the present disclosure.

Referring to FIG. 9, the electronic device 100 may determine the number of tiles of a central band 900 of the sphere using Equation (11). At this point, the electronic device 100 may determine the number of tiles of other bands 910 and 920 based on the number of tiles of the central band 900. For example, the electronic device 100 may determine the number of tiles of bands forming the sphere using Equation (12).

$$T {N}_{i} = ceil ( {TN}_{MB} \times cos Pitch ) \\ {ID}_{i} = \frac{360}{{TN}_{i}} \qquad Equation ( 12 )$$

In Equation (12), TNᵢ is the number of tiles that can be obtained while rotating in the horizontal direction in an i-th band, CTN_{MB} is the number of tiles to obtain while rotating in the horizontal direction in the central band of a sphere so that images overlap, and a pitch is a rotation angle in the vertical direction in the sphere.

At this point, the electronic device 100 may calculate an image interval IDᵢ by a tile of an i-th band using TNᵢ as in Equation (10).

FIG. 4 is a flowchart illustrating a procedure for generating a panoramic image in an electronic device according to an embodiment of the present disclosure.

Referring to FIG. 4, the electronic device obtains a plurality of images in order to generate a panoramic image in operation 401. For example, the electronic device displays a reference frame including at least one tile for obtaining an image on the display unit 170 as illustrated in FIG. 7A or 7B. Thereafter, the electronic device may obtain an image of a point at which orientation information of the electronic device provided from the detecting unit 150 and position information of a tile included in the reference frame match via the camera unit 140. At this point, the tile may include fixed position information or relative position information depending on position information of a reference image. The electronic device displays the central points 715 and 717 of a region for obtaining an image on the display unit 170 as illustrated in FIG. 7C. Thereafter, the electronic device may obtain an image of a point at which orientation information of the electronic device 100 provided from the detecting unit 150 and position information of a region for obtaining an image match via the camera unit 140. For example, the electronic device may obtain an image of a point at which the central point 715 or 717 enters the inside of a circle 713 representing the direction of the camera unit 140 via the camera unit 140.

After obtaining a plurality of images for a panoramic image, the electronic device proceeds to operation 403 to correct a change of a color value and/or a brightness value occurring due to an exposure difference of adjacent images. At this point, the electronic device may correct a brightness value of images based on at least one of an average and a standard deviation of brightness values for an overlapping region when images are projected onto a sphere. For example, in the case where the electronic device synthesizes the first image illustrated in FIG. 10A and the second image illustrated in FIG. 10B as a panoramic image without exposure correction, the brightness and color of the synthesized image may not be constant due to an exposure difference of the first image and the second image as illustrated in FIG. 10C. Accordingly, the electronic device may correct the brightness value of the images based on at least one of an average brightness value and a standard deviation of brightness values of a region where images obtained in operation 401 overlap.

More specifically, the electronic device may correct an exposure difference between the first image and the second image based on a difference in an average brightness value of an overlapping region for the first image and the second image as in Equation (1). The electronic device may correct an exposure difference between the first image and the second image based on a ratio of a standard deviation for a brightness value of an overlapping region for the first image and the second image as in Equation (2). In addition, the electronic device may correct an exposure difference between the first image and the second image based on a ratio of an average brightness value of an overlapping region for the first image and the second image as in Equation (3). Here, the brightness value of images includes a brightness component (Y component) among YUV components, and a color value may include a UV component.

After correcting a change of a brightness value occurring due to an exposure difference of images, the electronic device may proceed to operation 405 to align images whose exposure difference has been corrected. For example, the electronic device may match and align overlapping regions of images via template matching. For example, the electronic device may correct a matching error of an overlapping region of images during spherical projection via template matching. For another example, the electronic device may correct a matching error of an overlapping region of images by changing the position, magnitude, and rotation of at least one overlapping image and aligning the images depending on input information provided from the input unit 180.

After aligning the images, the electronic device may proceed to operation 407 to project aligned 2-D images to a 3-D sphere to generate a panoramic image. For example, the electronic device may set a distance of a 2-D image from the central point of the sphere to a focal length f to change a coordinate (x, y) of a 2-D image to a 3-D spacial coordinate (x, y, f). Thereafter, the electronic device may project an image having a 3-D spacial coordinate onto the sphere using Equation (4) or (6). For example, the electronic device may transform a 3-D spacial coordinate of a 2-D image to a coordinate projected onto the sphere using Equation (4) or (6).

As described above, the electronic device may generate a panoramic image by projecting 2-D images onto a 3-D sphere. In this case, since boundaries of images may stand out, the electronic device may remove the boundary of an overlapping region of the images projected onto the sphere by blurring or mixing the boundary of the images projected onto the sphere.

The electronic device may transform a panoramic image generated by projecting a 2-D image onto the 3-D sphere and store the same. For example, the electronic device may store image data generated by projecting images onto the 3-D sphere in the form of 3-D mesh data. For another example, the electronic device may store panoramic image data in the form of a 2-D plane coordinate using Equation (13) or (14).

$$Δ x = \frac{X S Z}{360} , Δ y = \frac{Y S Z}{360} \\ x = Δ x ( φ + 180 ) , y = Δ y ( 90 - θ ) \qquad Equation ( 13 )$$

In Equation (13), x, y are 2-D plane coordinates to which a 3-D panoramic image coordinate has been mapped, θ and φ are angles of an image coordinate in a 3-D space by the sphere.

$$Δ x = \frac{X S Z}{360} , Δ y = \frac{Y S Z}{360} \\ φ = \frac{x}{Δ x} - 180 , θ = 90 - \frac{y}{Δ y} \qquad Equation ( 14 )$$

In Equation (14), x, y are 2-D plane coordinates to which a 3-D panoramic image coordinate has been mapped, θ and φ are angles of an image coordinate in a 3-D space by the sphere.

As described above, in a case of storing panoramic image data in the form of 3-D mesh data, the electronic device may reproduce a 3-D panoramic image via rendering using mesh data stored in the data storage 112.

In the above embodiment of the present disclosure, the electronic device displays a reference frame on the display unit 170 in order to obtain images for a panoramic image. At this point, the electronic device may display a reference frame including fixed position information on the display unit 170 to obtain images as illustrated in FIG. 5.

FIG. 5 is a flowchart illustrating a procedure for obtaining an image for generating a panoramic image in an electronic device according to an embodiment of the present disclosure.

Referring to FIG. 5, the electronic device determines whether a panoramic application is driven in operation 501. For example, the electronic device determines whether an application for providing a panoramic image generation service is driven.

If it is determined in operation 501 that the panoramic application is driven, the electronic device proceeds to operation 503 to display a reference frame for obtaining a panoramic image. For example, the electronic device may display a reference frame including at least one tile adjacent to the preview image 701 obtained via the camera unit 140 on the display unit 170 as illustrated in FIG. 7A. Accordingly, in the case where the direction of the camera unit 140 changes depending on the movement of the electronic device, the electronic device may change a tile displayed on the display unit 170. For another example, the electronic device may display an entire construction of a reference frame for obtaining an image to project onto a sphere as illustrated in FIG. 7B. For still another example, the electronic device may display the central points 715 and 717 of a region for obtaining an image to project onto the shaper using the point 711 for obtaining an image via the camera unit 140 as a reference as illustrated in FIG. 7C. At this point, the electronic device may represent information of a distance up to the point 711 obtaining an image by controlling at least one of the color, illuminance, and transparency of the central points 715 and 717 of the region for obtaining an image. In addition, the electronic device may display the direction of position information adjacent to the circle 713 representing the direction of the camera unit 140.

Thereafter, the electronic device proceeds to operation 505 to determine whether direction information of the electronic device and position information of a tile included in a reference frame match each other.

If it is determined in operation 505 that the orientation information of the electronic device and the position information of the tile included in the reference frame do not match each other, the electronic device proceeds to operation 503 to display a reference frame for obtaining a panoramic image. At this point, in the case where the direction of the camera unit 140 changes depending on the movement of the electronic device, the electronic device may change a tile displayed on the display unit 170.

On the other hand, if it is determined in operation 505 that the orientation information of the electronic device and the position information of the tile included in the reference frame match each other, the electronic device proceeds to operation 507 to obtain an image of a point where the orientation information of the electronic device and the position information of the tile included in the reference frame match each other via the camera unit 140. At this point, the electronic device may display an image obtained via the camera unit 140 on a tile where the orientation information of the electronic device and the position information match in the reference frame.

Thereafter, the electronic device proceeds to operation 403 of FIG. 4 to correct an exposure difference of images projected onto a sphere depending on an image obtained in operation 507.

The electronic device may display a reference frame including relative position information depending on position information of a reference image on the display unit 170 to obtain images as illustrated in FIG. 6.

FIG. 6 illustrates a procedure for obtaining an image for generating a panoramic image in an electronic device according to an embodiment of the present disclosure.

Referring to FIG. 6, the electronic device obtains a reference image via the camera unit 140 in operation 601. For example, the electronic device may determine whether a panoramic image generation icon is selected while providing a camera service. For another example, the electronic device may determine whether a panoramic image generation menu is selected while providing the camera service. For still another example, the electronic device may determine whether a voice instruction for executing panoramic image generation is input while providing the camera service.

In the case where a panoramic image generation event occurs, the electronic device proceeds to operation 603 to determine whether a panoramic image generation event occurs. For example, in the case where a panoramic image generation event occurs, the electronic device may display a preview image obtained via the camera unit 140 on the display unit 170. Thereafter, in the case where an image capturing event occurs, the electronic device may capture a preview image displayed on the display unit 170. At this point, the electronic device may determine whether an image capturing event occurs based on one of a selection of an image capturing icon displayed on the display unit 170 or an input of an image capturing button and detection of a gesture matching an image capturing event.

Thereafter, the electronic device proceeds to operation 605 to generate a reference frame based on an image obtained in operation 603. For example, the electronic device sets position information regarding each tile of a reference frame configured as in FIG. 7B using an image obtained in operation 603 as a reference.

After generating the reference frame, the electronic device proceeds to operation 607 to display a reference frame for obtaining a panoramic image. For example, the electronic device may display a reference frame including at least one tile adjacent to the preview image 701 obtained via the camera unit 140 on the display unit 170 as illustrated in FIG. 7A. Accordingly, in the case where the direction of the camera unit 140 changes depending on the movement of the electronic device, the electronic device may change a tile displayed on the display unit 170. For another example, the electronic device may display an entire construction of a reference frame for obtaining an image to project onto a sphere as illustrated in FIG. 7B. For still another example, the electronic device may display the central points 715 and 717 of a region for obtaining an image to project onto the sphere using the point 711 obtaining an image via the camera unit 140 as a reference as illustrated in FIG. 7C. At this point, the electronic device may represent information of a distance up to the point 711 obtaining an image by controlling at least one of the color, illuminance, and transparency of the central points 715 and 717 of the region for obtaining an image. In addition, the electronic device may display the direction of position information adjacent to the circle 713 representing the direction of the camera unit 140.

Thereafter, the electronic device proceeds to operation 609 to determine whether orientation information of the electronic device and position information of a tile included in a reference frame match each other.

If it is determined in operation 609 that the orientation information of the electronic device and the position information of the tile included in the reference frame do not match each other, the electronic device proceeds to operation 607 to display a reference frame for obtaining a panoramic image. At this point, in the case where the direction of the camera unit 140 changes depending on the movement of the electronic device, the electronic device may change a tile displayed on the display unit 170.

On the other hand, if it is determined in operation 609 that the orientation information of the electronic device and the position information of the tile included in the reference frame match each other, the electronic device proceeds to operation 611 to obtain an image of a point where the orientation information of the electronic device and the position information of the tile included in the reference frame match each other via the camera unit 140. At this point, the electronic device may display an image obtained via the camera unit 140 on a tile where the orientation information of the electronic device and the position information match in the reference frame.

Thereafter, the electronic device proceeds to operation 403 of FIG. 4 to correct an exposure difference of images projected onto a sphere depending on an image obtained in operation 611.

As described above, in the case where the electronic device obtains an image of a point where the orientation information of the electronic device and the position information of the tile match each other, an error by the detecting unit 150 and an error in an image obtain process may occur. Accordingly, the electronic device aligns images via template in order to reduce a matching error for an overlapping region of images. More specifically, the electronic device may align images as illustrated in FIG. 11.

FIG. 11 illustrates a procedure for aligning images in an electronic device according to an embodiment of the present disclosure.

Referring to FIG. 11, the electronic device corrects an exposure difference for adjacent images in operation 403 illustrated in FIG. 4, and then proceeds to operation 1101 to determine vertexes of an image to project onto a sphere. For example, the electronic device obtains a coordinate of a case where four vertexes of an image are projected onto a sphere.

FIG. 12 illustrates a screen construction for obtaining a vertex of an image in an electronic device according to an embodiment of the present disclosure.

Referring to FIG. 12, for example, in a case of sequentially obtaining a first image 1200 and a second image 1210, the electronic device may calculate coordinates 1202, 1204, 1206, 1208 via which four vertexes of the first image 1200 are projected onto the sphere, and coordinates 1212, 1214, 1216, 1218 via which four vertexes of the second image 1210 are projected onto the sphere. At this point, the electronic device may project the second image 1210 onto the first image 1200 in an overlapping manner.

Referring back to FIG. 11, after determining the vertexes of images, the electronic device proceeds to operation 1103 to extract an overlapping region where images overlap using a vertex of each image as a reference.

FIGS. 13A, 13B, and 13C illustrate a screen configuration for extracting an overlap region in an electronic device according to an embodiment of the present disclosure.

Referring to FIGS. 13A, 13B, and 13C, for example, the electronic device obtains images of up/down/left/right directions in order to project images onto the sphere. Accordingly, the electronic device may extract an overlapping region 1300 where images overlap in up/down/left/right directions as illustrated in FIG. 13A, an overlapping region 1310 where images overlap in left/right directions as illustrated in FIG. 13B, and an overlapping region 1320 where images overlap in up/down directions as illustrated in FIG. 13C. Additionally, to prevent an error from occurring when calculating correlation regarding overlapping regions 1300, 1310, and 1320, the electronic device may set the magnitudes of the overlapping regions 1300, 1310, and 1320 such that the overlapping regions 1300, 1310, and 1320 have a margin of up/down/left/right reference ratios (1302, 1312, and 1322). Here, the reference ratio includes 10%.

Thereafter, the electronic device proceeds to operation 1105 to calculate correlation of images for an overlapping region. For example, the electronic device may calculate a similarity for the overlapping region based on brightness information of images. At this point, the electronic device may determine correlation of images for the overlapping region using at least one of an SSD method, an SAD method, and a normal correlation coefficient method.

After calculating correlation of the images for the overlapping region, the electronic device may proceed to operation 1107 to change an angle of an overlapping image using one image as a reference in order to obtain an effect of moving on the sphere and accurately match overlapping regions of the images.

In the above embodiment of the present disclosure, the electronic device corrects an exposure difference of images obtained for generating a panoramic image and an overlapping region matching error, and projects the images onto the sphere to generate a panoramic image.

In another embodiment of the present disclosure, the electronic device may project images obtained for generating a panoramic image onto the sphere, and then correct an exposure difference of images projected onto the sphere and a matching error of the overlapping region.

In still another embodiment of the present disclosure, the electronic device may correct an exposure difference of images obtained for generating a panoramic image, and then project images whose exposure difference has been corrected onto the sphere. Thereafter, the electronic device may correct a matching error of the overlapping region of the images projected onto the sphere.

FIG. 17 illustrates a software configuration of an electronic device according to an embodiment of the present disclosure.

Referring to FIG. 17, the electronic device may generate a panoramic image using a software of various structures. For example, the electronic device may generate a panoramic image using a software structure including an application, an application framework, a library, a linux kernel, and the like.

In the case where a mobile communication terminal generates a panoramic image, the mobile communication terminal may be configured as illustrated in FIG. 18.

FIG. 18 is a block diagram of an electronic device according to an embodiment of the present disclosure.

Referring to FIG. 18, the electronic device may be configured similarly with the electronic device illustrated in FIG. 1. However, the electronic device of FIG. 18 may further include a separate communication processor for controlling communication in the structure of the processor unit 120 of the electronic device illustrated in FIG. 1.

At this point, the electronic device may allow the application processor to execute a panoramic image program stored in the memory to generate a panoramic image.

As described above, the electronic device may generate not only images of a specific direction but also images of all directions as one panoramic image by projecting images obtained via the camera onto the sphere and generating a panoramic image.

The electronic device may easily obtain images used for generating a panoramic image by displaying reference frame information capable of obtaining a plurality of images to project onto the sphere based on movement information of the electronic device.

Certain aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include a Read-Only Memory (ROM), a RAM, Compact Disc-ROMs (CD-ROMs), magnetic tapes, floppy disks, and optical data storage devices. The non-transitory computer readable recording medium can also be distributed over network coupled computer systems so that the computer readable code is stored and executed in a distributed fashion. In addition, functional programs, code, and code segments for accomplishing the present disclosure can be easily construed by programmers skilled in the art to which the present disclosure pertains.

At this point it should be noted that the various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include a ROM, a RAM, CD-ROMs, magnetic tapes, floppy disks, and optical data storage devices. The processor readable mediums can also be distributed over network coupled computer systems so that the instructions are stored and executed in a distributed fashion. In addition, functional computer programs, instructions, and instruction segments for accomplishing the present disclosure can be easily construed by programmers skilled in the art to which the present disclosure pertains.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method in an electronic device, the method comprising:
displaying guide information for guiding a movement of the electronic device on a display of the electronic device in order to obtain images forming at least a portion of a panoramic image;
obtaining at least one image based on the guide information and orientation information of the electronic device;
correcting a color of images based on at least a portion of the obtained images in order to form at least the portion of the panoramic image;
aligning the images based on at least a portion where the obtained images have overlapped; and
generating the panoramic image by projecting the aligned images onto a three-Dimensional (3-D) sphere.

2. The method of claim 1, wherein the color of the images comprises at least one of a white balance, an exposure, and a color value.

3. The method of claim 1, further comprising, before obtaining the at least one image, measuring at least one of a movement, a position, and a direction of the electronic device using a movement sensor of the electronic device.

4. The method of claim 3, wherein the movement sensor comprises at least one of a gravity sensor, a geomagnetic sensor, a gyro sensor, a digital compass, a horizontal sensor, and an acceleration sensor.

5. The method of claim 1, wherein the guide information comprises at least one image capturing region for obtaining regions forming at least the portion of the panoramic image in a form of a sphere.

6. The method of claim 1, further comprising:
before displaying the guide information, determining the number of image capturing regions to display on respective bands forming the sphere from the guide information of the spherical shape based on a focal length and an angle of view of a camera,
wherein the bands of the sphere comprise at least one region dividing the sphere horizontally.

7. The method of claim 1, wherein the displaying of the guide information comprises extracting and displaying at least one image capturing region among the image capturing regions forming the guide information of the spherical shape based on a movement direction of the electronic device.

8. The method of claim 1, wherein the guide information comprises at least one of a movement, a position, and a direction of the electronic device for obtaining an image, and
wherein the orientation information of the electronic device comprises at least one of the position, the movement, and the direction of the electronic device.

9. The method of claim 1, wherein the correcting of the color of the images comprises, when obtaining a plurality of images, correcting a difference in a brightness value and/or a color value of an overlapping region when the images are projected onto the sphere.

10. The method of claim 1, wherein the aligning of the images comprises correcting a matching error of an overlapping region of the images by controlling a rotation angle when projecting other images onto the sphere using one of images comprising the overlapping region as a reference.

11. The method of claim 1, wherein the generating of the panoramic image comprises:
transforming a two-Dimensional (2-D) coordinate value of the at least one image to a 3-D coordinate value using a virtual focal length; and
transforming a 3-D coordinate value of the image to a coordinate value projected onto the sphere based on a radius of the sphere to generate a panoramic image projected onto the 3-D sphere.

12. The method of claim 1, further comprising, after projecting the at least one image onto the 3-D sphere, mixing or blurring a boundary region of images.

13. The method of claim 1, further comprising:
transforming a 3-D coordinate value of the panoramic image projected onto the sphere to data of a mesh structure and storing the transformed data of a mesh structure.

14. The method of claim 1, further comprising:
transforming a 3-D coordinate value of the panoramic image projected onto the sphere to a 2-D plane coordinate value and storing the transformed 2-D plane coordinate value.

15. The method of claim 1, wherein the displaying of the guide information comprises:
displaying a central point of at least one region for obtaining an image based on movement information of the electronic device.

16. The method of claim 15, wherein the displayed central point represents information depending on a movement direction of the electronic device by controlling at least one of a color, an illuminance, and a transparency representing the central point.

17. An electronic device comprising:
a camera;
a detecting unit configured to detect a movement of the electronic device;
a display unit;
one or more processors;
a memory; and
a program stored in the memory and driven by the one or more processors,
wherein the program displays guide information for guiding the movement of the electronic device on the display unit of the electronic device in order to obtain images forming at least a portion of a panoramic image, obtains at least one image based on the guide information and orientation information of the electronic device, corrects a color of images based on at least a portion of the obtained images in order to form at least the portion of the panoramic image, aligns the images based on at least a portion where the obtained images have overlapped, and generates the panoramic image by projecting the aligned images onto a three-Dimensional (3-D) sphere.

18. The electronic device of claim 17, wherein the color of the images comprises at least one of a white balance, an exposure, and a color value.

19. The electronic device of claim 17, wherein, before obtaining the at least one image, the program measures at least one of a movement, an angle, and a direction of the electronic device using a movement sensor of the electronic device.

20. The electronic device of claim 19, wherein the movement sensor comprises at least one of a gravity sensor, a geomagnetic sensor, a gyro sensor, a digital compass, a horizontal sensor, and an acceleration sensor.

21. The electronic device of claim 17, wherein the guide information comprises at least one image capturing region for obtaining regions forming at least the portion of the panoramic image in a form of the sphere.

22. The electronic device of claim 17, wherein the program determines the number of image capturing regions to display on respective bands forming the sphere from the guide information of the spherical shape based on a focal length and an angle of view of the camera, and wherein the bands of the sphere comprise at least one region dividing the sphere horizontally.

23. The electronic device of claim 17, wherein the electronic device is further configured to extract at least one image capturing region among the image capturing regions forming the guide information of the spherical shape based on a movement direction of the electronic device, and to display the same on the display unit.

24. The electronic device of claim 17, wherein the guide information comprises at least one of a movement, a position, and a direction of the electronic device for obtaining an image, and wherein the movement information of the electronic device comprises at least one of the position, the movement, and the direction of the electronic device.

25. The electronic device of claim 17, wherein, when obtaining a plurality of images, the program corrects a difference in a brightness value and/or a color value of an overlapping region when the images are projected onto the sphere.

26. The electronic device of claim 17, wherein the program corrects a matching error of an overlapping region of the images by controlling a rotation angle when projecting other images onto the sphere using one of images comprising the overlapping region as a reference.

27. The electronic device of claim 17, wherein the program transforms a two-Dimensional (2-D) coordinate value of the at least one image to a 3-D coordinate value using a virtual focal length, and
transforms a 3-D coordinate value of the at least one image to a coordinate value projected onto the sphere based on a radius of the sphere to generate a panoramic image projected onto the 3-D sphere.

28. The electronic device of claim 17, wherein, after projecting the at least one image onto the 3-D sphere, the program mixes or blurs a boundary region of images.

29. The electronic device of claim 17, wherein the program transforms a 3-D coordinate value of the panoramic image projected onto the sphere to data of a mesh structure and stores the transformed data of a mesh structure in a storage.

30. The electronic device of claim 17, wherein the program transforms a 3-D coordinate value of the panoramic image projected onto the sphere to a 2-D plane coordinate value and stores the transformed 2-D plane coordinate value in a storage.

31. The electronic device of claim 17, wherein the program displays a central point of at least one region for obtaining an image based on movement information of the electronic device.

32. The electronic device of claim 31, wherein the displayed central point represents information depending on a movement direction of the electronic device by controlling at least one of a color, an illuminance, and a transparency representing the central point.

33. A method for generating an image in an electronic device, the method comprising:
displaying guide information for guiding a movement of the electronic device on a display of the electronic device in order to obtain an image forming at least a portion of a panoramic image;
obtaining at least one image based on orientation information of the electronic device and the guide information;
transforming a two-Dimensional (2-D) coordinate value of the at least one image into a three-Dimensional (3-D) coordinate value; and
projecting the at least one image onto a 3-D sphere using the 3-D coordinate value of the image.

34. The method of claim 33, further comprising:
correcting a color for an overlapping region of images projected onto the 3-D sphere; and
aligning the images based on at least a portion where the images overlap.

35. The method of claim 33, wherein the guide information comprises at least one image capturing region for obtaining regions forming at least the portion of the panoramic image in a form of the sphere.

36. The method of claim 33, further comprising, after projecting the image onto the 3-D sphere, mixing or blurring a boundary region of the images.

37. A method for operating an electronic device, the method comprising:
displaying at least a portion of a plurality of guides generated based on at least a portion of a camera's angle of the electronic device on a display of the electronic device in order to obtain images forming at least a portion of a three-Dimensional (3-D) projected panoramic image, each of the plurality of guides corresponding to one of a plurality of coordinate values;
determining a value representing a movement direction of the electronic device using a sensor of the electronic device;
comparing the determined value with at least one of the coordinate values;
obtaining an image using the camera based on at least a portion of the comparison result in the comparison operation; and
generating a panoramic image on the display by projecting an image stored in advance in the electronic device and the obtained image onto a 3-D sphere.

38. The method of claim 37, wherein the sensor comprises at least one of a gravity sensor, a geomagnetic sensor, a gyro sensor, a digital compass, a horizontal sensor, and an acceleration sensor.

39. A non-transitory computer-readable storage medium configured to store a computer program of instructions configured to be readable by at least one processor for instructing the at least one processor to execute a computer process for performing the method of claim 1.
